(19) United States
(12) Patent Application Publication
(10) Pub. No.: US 2012/0288614 A1
(43) Pub. Date: Nov. 15, 2012

(54) METHOD OF TREATING SOLID AND SEMI-SOLID FOODS TO REDUCE MICROORGANISMS AND ENZYMES IN THE FOOD

(76) Inventors: Nicole Favreau, Waltham, MA (US); Patrick J. Marek, Shrewsbury, MA (US)

(21) Appl. No.: 13/103,334

(22) Filed: May 9, 2011

(51) Int. Cl. A23L 3/3418

(52) U.S. Cl. 426/665

(57) ABSTRACT

A method of treating solid and semi-solid foods to reduce microorganisms and enzymes in the food including introducing solid or semi-solid food to a pressure vessel, exposing the food in the vessel to supercritical carbon dioxide to reduce the one or more microorganisms or enzymes, exhausting the supercritical carbon dioxide at a rate to maintain organoleptic integrity of the food.

### FIELD OF THE INVENTION

This invention relates to a method of reducing microbial and enzymatic activity in solid or semi-solid food to extend shelf life.

### BACKGROUND OF THE INVENTION

There are many methods of improving shelf life of liquid foods such as orange juice, apple juice, milk, peanut butter, soup, sauces, dairy products and the like. The goal is to reduce microbial and enzymatic activity. Thermal methods and high pressure methods are often used commercially. Other techniques include nuclear irradiation, ultraviolet exposure, microwave exposure and high pressure homogenization. All of these suffer various shortcomings including the danger associated with these agents and the expense of the equipment. In addition many of these approaches deleteriously affect the organoleptic features of the food causing deodorizing, loss of volatile components and loss of flavor, fragrance and texture.

In another approach supercritical carbon dioxide (SCCO₂) is being used to reduce microbial and enzymatic activity in liquid foods such as juices, U.S. Patent Application No. 2004/0131739 A1, beer and wine, U.S. Patent Application No. 2004/0234661 A1. See also PCT Patent No. WO 2004/021807 A1. SCCO₂ is not so detrimental to the integrity of the food (off-flavors, odors, loss of texture). The mechanism that makes SCCO₂ effective is not completely understood. One theory is that the quick change in pH caused by carboxyl acid is the contributor, while others believe that its effectiveness is due to cell rupture. In any case SCCO₂ treatment gives good results: extended shelf life with little damage to the liquid food.

There is an established desire for a non-thermal, non-destructive safe treatment for solid and semi-solid food that will destroy unwanted enzymes and microbes before spoilage, browning or other damage but will not ruin the appeal or palatability of the solid food. The need is more pronounced in military applications where food may need to have a shelf life measured in years and the quality and variety have a real effect on the troop's morale.

### SUMMARY OF THE INVENTION

It is therefore an object of this invention to provide a method of treating solid and semi-solid foods to reduce microorganisms or enzymes in the food.

It is a further object of this invention to provide such a method of treating solid and semi-solid foods to reduce microorganisms or enzymes in the food which preserves the integrity of the food maintaining its appeal and palatability.

It is a further object of this invention to provide such a method of treating solid and semi-solid foods to reduce microorganisms or enzymes in the food which maintains the organoleptic features of the food preserving flavor, fragrance and texture.

It is a further object of this invention to provide such a method of treating solid and semi-solid foods to reduce microorganisms or enzymes in the food which is simple, inexpensive and can be effected with conventional equipment.

The invention results from the realization that a method of treating solid and semi-solid foods to reduce microorganisms and enzymes in the food which maintains organoleptic features flavor, fragrance, texture, and its appeal and palatability can be achieved by introducing solid or semi-solid food to a pressure vessel, exposing the food in the vessel to supercritical carbon dioxide to reduce the one or more microorganisms or enzymes, exhausting the supercritical carbon dioxide at a rate to maintain organoleptic integrity of the food.

The subject invention, however, in other embodiments, need not achieve all these objectives and the claims hereof should not be limited to structures or methods capable of achieving these objectives.

This invention features a method of treating solid and semi-solid foods to reduce microorganisms and enzymes in the food including introducing solid or semi-solid food to a pressure vessel, exposing the food in the vessel to supercritical carbon dioxide to reduce the one or more microorganisms or enzymes, exhausting the supercritical carbon dioxide at a rate to maintain organoleptic integrity of the food.

In one embodiment the pressure range may be from 500 to 10,000 psi inclusive. The exposure time may be from less than 1 to 180 minutes. The exhaust time may be from 10 to 120 minutes. The temperature may be approximately 40° C.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a simplified schematic diagram of an extractor which can be used to perform one embodiment of the process of this invention;

FIG. 2 is a graph illustrating enzymatic inactivity results for potatoes;

FIG. 3 is a photographic image of processed and unprocessed potatoes;

FIG. 4 is a fluorescent image of processed and unprocessed potatoes;

FIG. 5 is a photographic image of apples showing browning in treated and untreated apples;

FIG. 6 is a graph illustrating the enzymatic activity of apples at various treatment parameters;

FIG. 7 is photographic images of treated and untreated beef showing the dramatic reduction in Escherichia coli colonies;

FIG. 8 is a graph illustrating the results for Escherichia coli inoculated beef at various times at 38° C.;

FIG. 9 is a graph similar to FIG. 8 for the inoculated beef at various times at 42° C.;

FIG. 10 is a photographic image of summer sausage, hard salami and pastrami in Tyvek pouches in wire baskets for processing;

FIG. 11 is a photographic image of intact summer sausage after processing; and

FIG. 12 is a photographic image of sliced summer sausage after processing.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

The non-thermal processing of solid and semi-solid foods using supercritical carbon dioxide (SCCO₂) to inactivate enzymes and microbes can be accomplished in continuous or batch processing. Solid foods include all fruits, vegetables, meats, starches, and baked items and semi-solid foods include all sauces, dressings, yogurt, spreads and ice cream.

In one embodiment batch processing is performed in small quantities in an SFT-100SFE extractor made by Supercritical Fluids Technology of Newark, Delaware. This invention illustrates that supercritical carbon dioxide (SCCO₂) inactivates enzymes and microbes without subjecting solid and semi-solid foods to damaging side-effects. A supercritical fluid is a fluid in a state where its temperature and pressure are above its critical point. In this state, it takes on the properties midway between a liquid and a gas, exhibiting the diffusivity of a gas and the solvency of a liquid. SCCO₂ processing manipulates the temperature and pressure of liquid CO₂ in a pump until it is in its supercritical state. The SCCO₂ is then introduced to the food and soaked for a pre-determined time in a vessel.

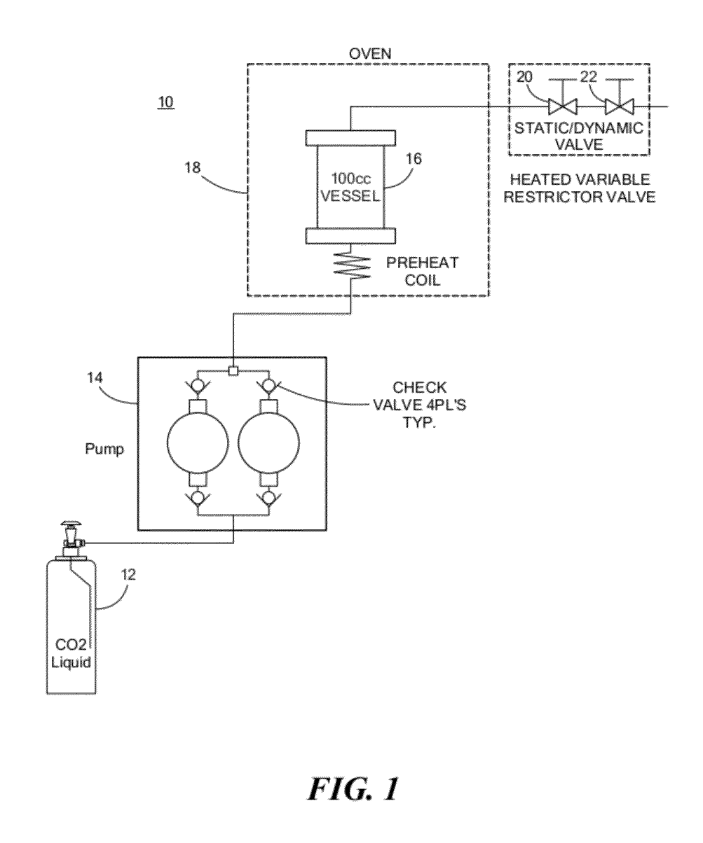

The above extractor 10 is shown in simplified schematic form in FIG. 1 where CO₂ liquid from a tank 12 is delivered to a dual pump system 14 where the CO₂ is pressurized for delivery to a 100 cc vessel 16 in oven 18. After a predetermined time at supercritical state the temperature is decreased and the pressure is gradually released through static/dynamic valves 20, 22. Larger quantities of solid and semi-solid foods have been processed in the 20 liter Nova 2200 supercritical carbon dioxide stabilizer made by NovaSterils of Lansing, N.Y.

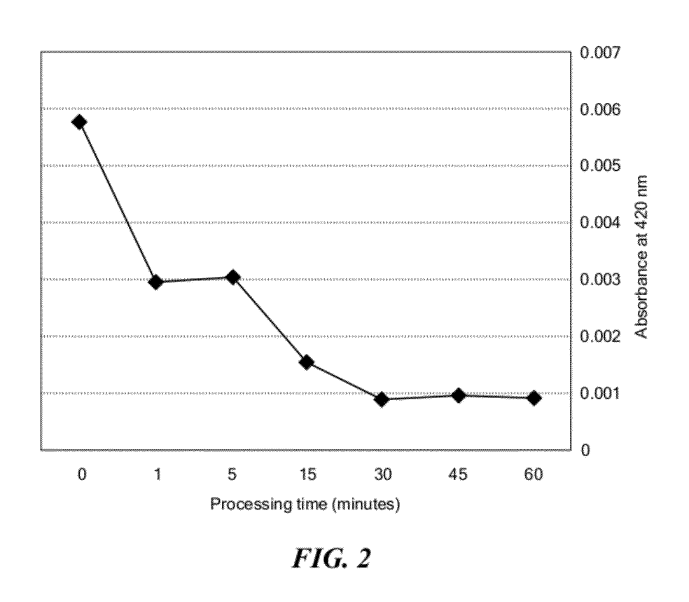

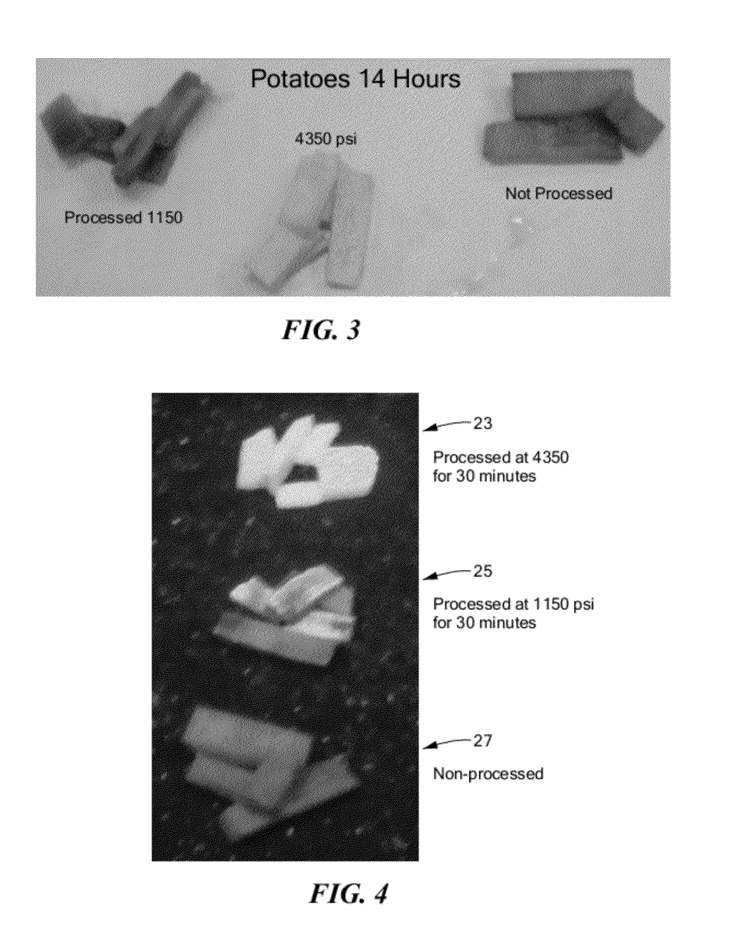

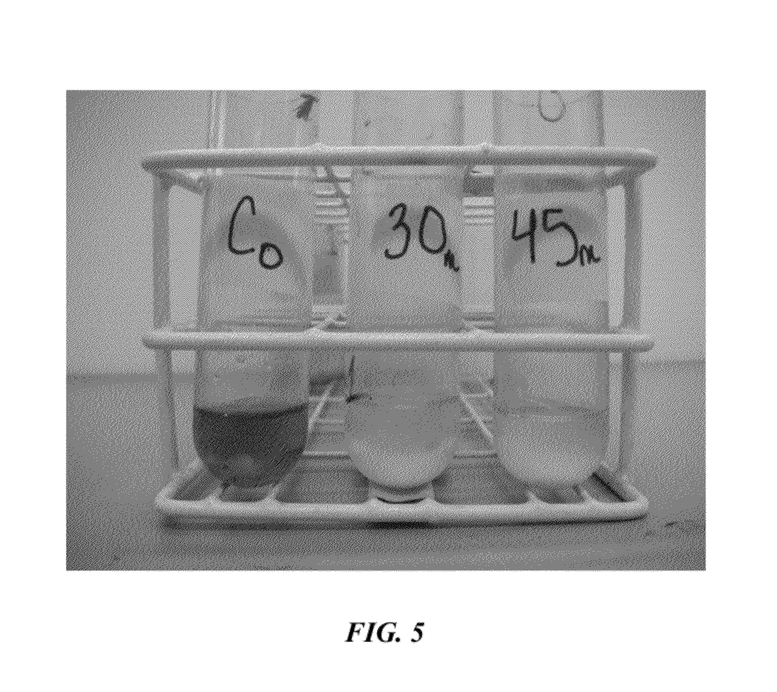

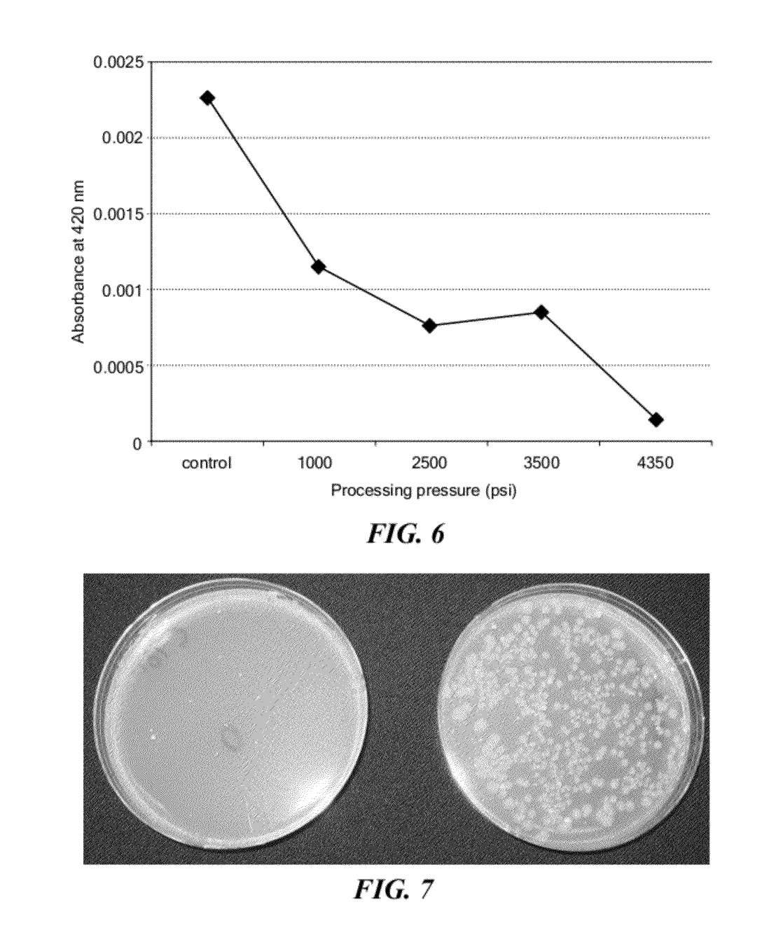

Using the SFT-100 top round steaks were processed according to this invention with unexpected excellent results both as to inactivation of enzymes and microbes and preservation of organoleptic features. With regard to potatoes, the enzymatic inactivation results are shown in FIG. 2 where the Polyphenoloxidase (PPO) extracted from a potato and processed for 30 minutes or longer (up to 60 minutes) showed negligible enzymatic activity. A photo taken of processed and unprocessed potatoes, FIG. 3, after remaining in a 40° F. box for 14 hours shows that the potatoes processed at 4350 psi for 30 minutes did not undergo enzymatic browning. A fluorescent depiction, FIG. 4, of processed and non-processed potatoes where enzymatic activity quenches fluorescence shows the potatoes that were processed at 4350 psi fluoresce, demonstrating the lack of enzymatic activity. The upper view was processed at 4350 psi for 30 minutes 23, the middle was processed at 1150 psi for 30 minutes 25, and the bottom view was not processed 27. Similar results were obtained for apples as can be seen in FIG. 5 where PPO was extracted from apples prior to the spectrum measurement. The control (left) untreated sample exhibits browning, while the two treated apples PPO (30 and 45 minutes) samples do not. The enzymatic activity of apple PPO processed at varying pressure for 30 minutes shows almost complete inactivation was achieved at 4350 psi, FIG. 6.

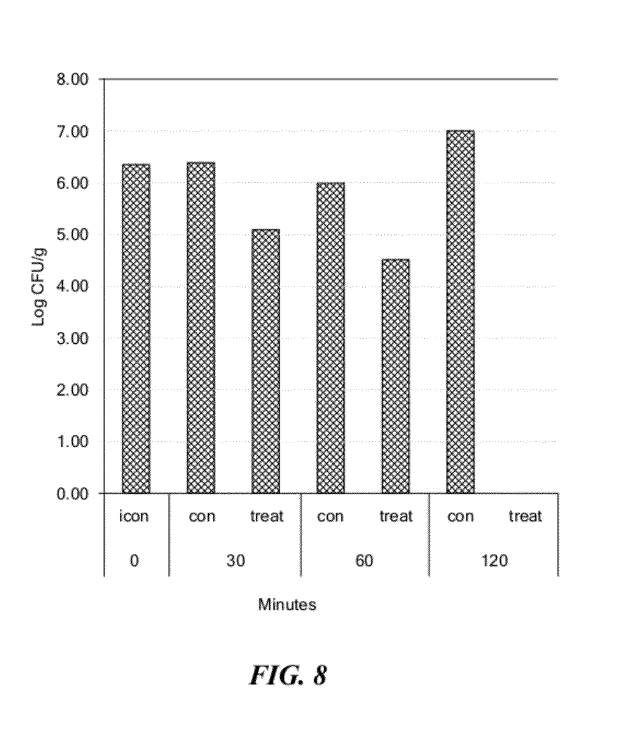

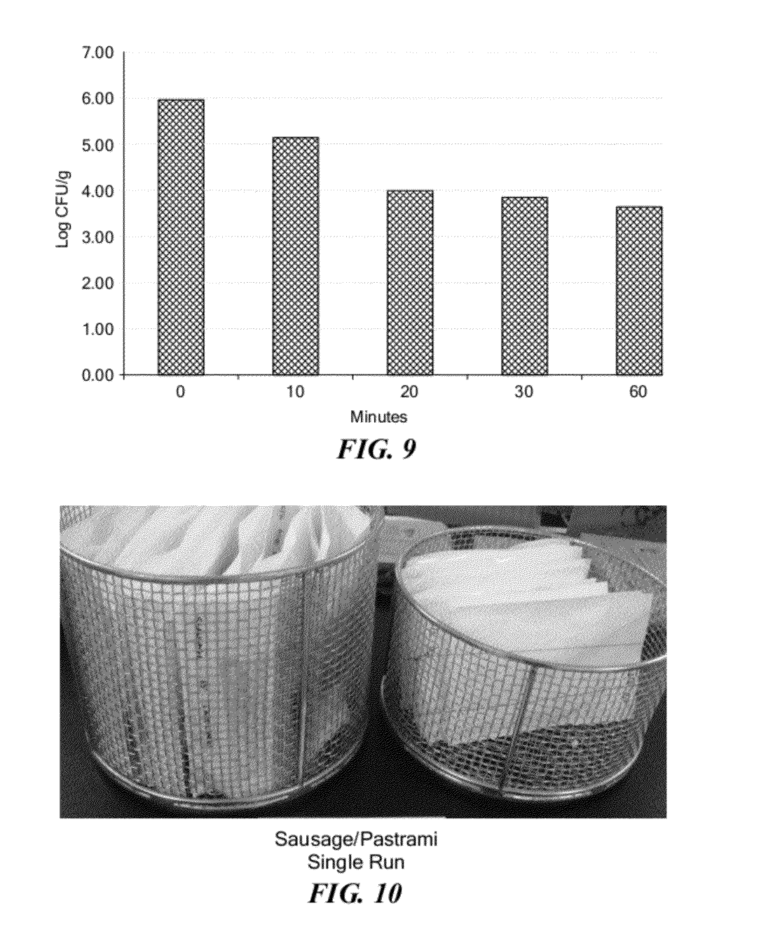

Top round steak was purchased from a local grocery chain and cut into sample cubes measuring approximately 1×4 cm. The sample meat cubes were surface inoculated by dipping them into prepared cultures of Escherichia coli ATCC 15997 or E. coli O157:H7 ATCC 43888 at 10⁶ cfu/ml in sterile phosphate buffered saline (PBS) at room temperature for a soak time of 20 seconds. After soaking, excess inoculum was allowed to drain to one corner of the meat cube and blotted with an absorbent towel. Then, the sample cubes were transferred to a preweighed sample tray and allowed to air dry for 15 to 20 minutes, or until the sample no longer had standing fluid. The weight of each sample was determined and the difference was recorded per treatment. The inoculated sample cubes were transferred to sterile 15 ml falcon tubes, capped and held at 4° C. before processing. The cubes of beef were treated at varying pressures, temperatures and times. After treatment, each meat cube was transferred to a small sterile stomacher bag with 10 ml of PBS 0.3% Tween 20 and homogenized in the stomacher for 2 minutes. One ml aliquots of homogenate was serially diluted in PBS and then 1041 (from the appropriate dilution) was spread plated onto MacConkey Sorbitol agar and plate count agar and, incubated aerobically at 37° C. for 24 hours before enumeration. In FIG. 7 the plates of the treated and non-treated E. coli ATCC15997 inoculated beef post incubation are shown. The non-treated sample (right) formed colonies that were too numerous to count, and the treated sample presented very few colonies. The E. coli O157:H7 ATCC 43888 inoculated beef treated at various times at 4350 psi and 38° C. produced the above results in FIG. 8 following an 18-hour incubation period. FIG. 9 shows the inactivation of E. coli 0157:H7 ATCC 43888 on top round beef at 42° C. and 4350 psi for varying times.

The need for a larger SCCO2 processing instrument for large scale productions was recognized, but a commercially available one was not available. The Nova2200™ is a commercial sterilizer used to sterilize different types of musculo-skeletal tissues such as bone, tendon and skin. Whole, ¼″, ⅛″ and 1/16″ slices of pastrami, salami and sausage were placed in Tyvek sterilization pouches. The pouches were placed in mesh bins, FIG. 10, and placed in the holding vessel of the Nova2200™. Lactic acid was added to a pad at the bottom of the holding vessel as an added acidulant. The operating parameters were as follows: 10 and 30 minute processing times and processed at 1436 psi. Microbial and preliminary sensory analyses were performed on the medium moisture meats.

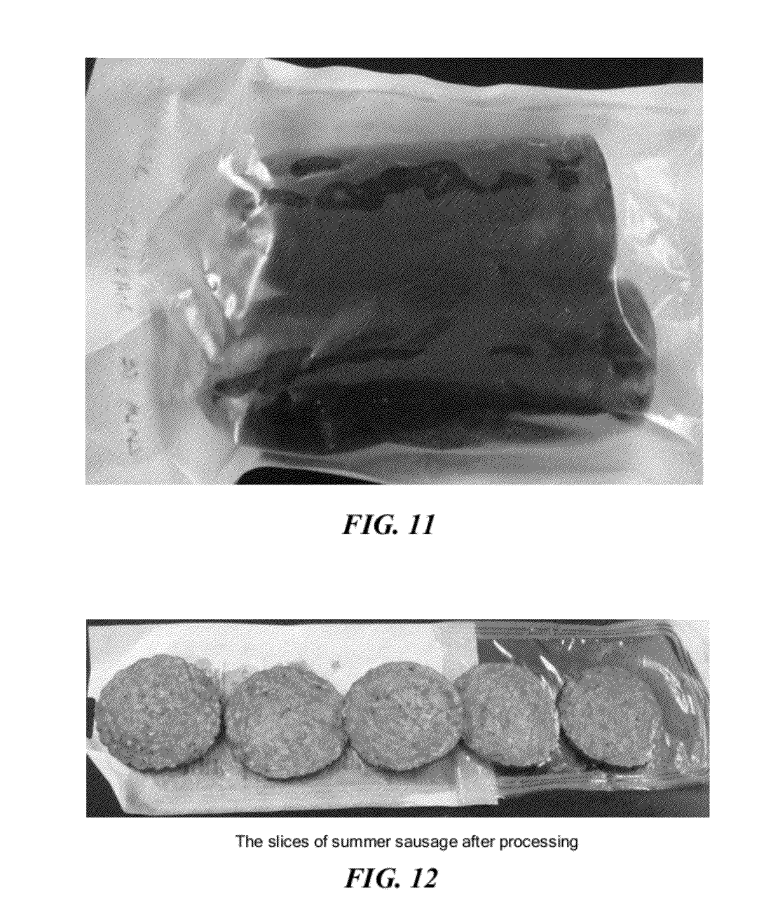

Microbiological analysis was performed on the three different meat products (hard salami, summer sausage and smoked pastrami) processed with SCCO₂. Sampling was conducted on initial products (controls) and on post processed enriched meat samples that were incubated for 10 days at 35° C. The lactic acid bacteria (LAB) and aerobic plate count (APC) were determined for each product by grinding in a sterile stainless steel blender jar without liquid. Twenty-five grams of each sample was transferred to a sterile filtered stomacher bag containing 250 ml of sterile Butterfield's buffer and then stomached for two minutes on medium in a Seward Stomacher. One ml of the resulting stomachate was serially diluted and then 100 μl was spread plated on MRS (de Man, Rogosa and Sharpe) agar for the LAB while 1 ml aliquots from each dilution were used on APC Petrifilem 3M® for the APC count. The MRS plates were incubated anaerobically at 37° C. for 48 hours while the APC films were incubated aerobically at 35° C. for 24 hours before enumeration. Intact summer sausage after processing is shown in FIG. 11 where there is some fat extraction at the bottom of the pouch, but it did not affect the sensory results. The slices of summer sausage after processing, FIG. 12, appear virtually unaffected. The meats (slices and whole) maintained structural integrity during and after processing. The informal sensory evaluation concluded that the appearance, odor, taste, texture and overall quality of the SCCO₂ processed meat were above acceptable and equal to that of the non-processed meats. Significant reductions of 4.86 Log CFU/g and 3.98 Log CFU/g in the LAB and APC (respectively) were measured in the hard salami processed with SCCO2 for 30 minutes. SCCO₂ processing on model systems, semi-solid and solid foods has rendered significant reductions in enzymatic activity and microbial growth. The process does not result in a negative effect on the organoleptic properties or physical state of the food items.

Specific examples with various processing parameters are presented below:

| | | | Soak- | Ex- | Results: | Results: |
|---|---|---|---|---|---|---|
| | Temper- | Pres- | ing | haust | Enzymatic | Microbial |
| | ature | sure | Time | time | (% inacti- | (log |
| Material | [C.] | (psi) | (min) | (min) | vation) | reduction) |
| L. reuteri in | 40 | 1070 | 30 | 30 | | 1 |
| sterile | 40 | 1070 | 60 | 30 | | 3 |
| phosphate | 40 | 1070 | 120 | 30 | | 6 |
| buffer | 40 | 3620 | 30 | 30 | | 1 |
| | 40 | 3620 | 60 | 30 | | 6 |
| | 40 | 3620 | 120 | 30 | | 6 |
| | 40 | 4350 | 30 | 30 | | 2 |
| | 40 | 4350 | 60 | 30 | | 7 |
| | 40 | 4350 | 120 | 30 | | 7 |
| potatoes | 40 | 4350 | 60 | 30 | 100 | |
| | 40 | 4350 | 30 | 30 | 100 | |
| | 42 | 3620 | 20 | 20 | 100 | |
| apples | 40 | 1000 | 30 | 30 | 49 | |
| | 40 | 2500 | 30 | 30 | 67 | |
| | 40 | 3500 | 30 | 30 | 62 | |
| | 40 | 4350 | 30 | 30 | 100 | |
| lettuce | 40 | 3000 | 60 | 30 | 91 | |
| | 40 | 3000 | 45 | 30 | 90 | |
| | 40 | 3000 | 30 | 30 | 91 | |
| | 40 | 3000 | 15 | 30 | 70 | |
| | 40 | 3000 | 1 | 30 | 49 | |
| | 40 | 3000 | 5 | 30 | 47 | |
| Cubes of beef | 40 | 1060 | 60 | 30 | | 0.8 |
| inoculated with | 40 | 4350 | 30 | 30 | | 1.5 |
| E. coli 15997 | 40 | 4350 | 60 | 30 | | 2.6 |
| Cubes of beef | 42 | 4350 | 10 | 30 | | 1 |
| inoculated with | 42 | 4350 | 20 | 30 | | 2 |
| E. coli | 42 | 4350 | 30 | 30 | | 2.1 |
| 0157:H7 | 42 | 4350 | 60 | 30 | | 2.5 |
| | 38 | 4350 | 30 | 30 | | 2 |
| | 38 | 4350 | 60 | 30 | | 2.5 |
| | 38 | 4350 | 120 | 30 | | 7 |

Also considered were temperatures from 30-50° C., pressures of 500-10,000 psi, soak times of under 1 minute to more than 180 minutes and exhaust times of 10 to 120 minutes.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A method of treating solid and semi-solid foods to reduce microorganisms and enzymes in the food comprising;
introducing solid or semi-solid food to a pressure vessel;
exposing the food in the vessel to supercritical carbon dioxide to reduce the one or more microorganisms or enzymes;
exhausting the supercritical carbon dioxide at a rate to maintain organoleptic integrity of the food.

2. The method of treating solid and semi-solid foods of claim 1 in which the pressure range is from 500 to 10,000 psi inclusive.

3. The method of treating solid and semi-solid foods of claim 1 in which the exposure time is from less than 1 to 180 minutes.

4. The method of treating solid and semi-solid foods of claim 1 in which the exhaust time is from 10 to 120 minutes.

5. The method of treating solid and semi-solid foods of claim 1 in which the temperature is approximately 40° C.
